(19) United States
(12) Patent Application Publication
(10) Pub. No.: US 2013/0018594 A1
(43) Pub. Date: Jan. 17, 2013

(54) APPARATUS AND METHOD FOR IDENTIFYING SECONDARY STRUCTURE OF PROTEIN USING ALPHA CARBON COORDINATES

(71) Applicants: Kwang-Hwi Cho, Seoul (KR); Kyoung-Tai No, Seoul (KR); Min-Jae You, Seoul (KR)

(72) Inventors: Kwang-Hwi Cho, Seoul (KR); Kyoung-Tai No, Seoul (KR); Min-Jae You, Seoul (KR)

(73) Assignee: FOUNDATION OF SOONGSIL UNIVERSITY-INDUSTRY COOPERATION, Seoul (KR)

(21) Appl. No.: 13/635,401

(22) PCT Filed: Sep. 6, 2010
(86) PCT No.: PCT/KR10/06033

§ 371 Date: Sep. 14, 2012

(30) Foreign Application Priority Data
Apr. 7, 2010 (KR) 10-2010-0031907

(51) Int. Cl. G06F 19/10

(52) U.S. Cl. 702/19

(57) ABSTRACT

This invention relates to an apparatus and method for identifying the secondary structure of a protein using alpha carbon coordinates. The apparatus includes a pseudo center fixing unit receiving a series of alpha carbon coordinates of amino acid sequences of a target protein so that pseudo centers corresponding to respective alpha carbons are disposed at positions fixed between the respective alpha carbons and alpha carbons adjacent thereto; a helix determination unit determining, based on a dihedral angle and a distance between a preset number of consecutive pseudo centers, whether the secondary structure formed by amino acids corresponding to the consecutive pseudo centers is a helix; and a strand determination unit determining, based on distances between pseudo centers of different pseudo center sequences in a plurality of pseudo center sequences having a preset number of consecutive pseudo centers among pseudo centers other than those corresponding to the helix, whether the secondary structure formed by amino acids corresponding to the pseudo centers of respective pseudo center sequences is a strand. According to this invention, the secondary structure including amino acids corresponding to pseudo centers can be identified based on the dihedral angle or the distance between pseudo centers using pseudo centers fixed between alpha carbons, thus attaining increased accuracy, compared to conventional methods using alpha carbon coordinates.

### CROSS-REFERENCE TO RELATED APPLICATION

This application is the National Stage of International Application No. PCT/KR2010/006033, filed on Sep. 6, 2010, and claims priority to and the benefit of Korean Patent Application No. 2010-0031907, filed on Apr. 7, 2010, the disclosure of which is incorporated herein by reference in its entirety.

### TECHNICAL FIELD

The present invention relates to an apparatus and method for identifying the secondary structure of a protein using alpha carbon coordinates, and more particularly to an apparatus and method for identifying the secondary structure of a protein when only alpha carbon coordinates of the protein are given.

### BACKGROUND ART

The structure of a protein which is a biomolecule responsible for important functions related to life phenomenon in vivo is receiving attention because the functions thereof are closely related to its structure. The structure of a protein is defined as primary, secondary, tertiary and quaternary structures. The primary structure indicates information about the amino acid sequences of the protein, and the secondary structure indicates a helix, a strand or a random coil, which are predetermined patterns made up of amino acid residues. Also the tertiary structure indicates a three-dimensional structure composed of secondary structures, and the quaternary structure indicates the form in which some protein chains are provided to interact with each other. Among such protein structures, the secondary structure is the base of the tertiary structure, and thus the obvious definition of the secondary structure is regarded as important in terms of research into protein structures.

Methods of defining the secondary structure include using the pattern of hydrogen bonding between the hydrogen atom (H) of an amide and the oxygen atom (O) of a carbonyl from respective atom coordinates of the protein via X-ray or nuclear magnetic resonance (NMR). In order to utilize this method, the positions of atoms of the backbone among atoms of the protein such as H, N, C, O, etc., have to be accurately found out, and their coordinates are used to calculate the presence or absence of hydrogen bonds thereby determining the secondary structure. A typical program using this method is DSSP (Dictionary of Protein Secondary Structure).

When DSSP runs, it estimates the position of H using information about O, N and C of respective amino acids, calculates hydrogen bond energy using the coordinates of four atoms, defines the hydrogen bond when the calculated energy is less than −0.5 Kcal/mol, and determines the secondary structure based on information about the hydrogen bonds. The hydrogen bond energy is calculated by the following Equation 1.

$$E = {q}_{1} {q}_{2} [ \frac{1}{{r}_{ON}} + \frac{1}{{r}_{CH}} - \frac{1}{{r}_{OH}} - \frac{1}{{r}_{CN}} ] \cdot 332 K cal \text{/} mol \qquad [ Equation 1 ]$$

wherein q₁ is the charge amount of hydrogen, q₂ is the charge amount of oxygen, r_{ON} is the O—N distance, r_{CH} is the C—H distance, r_{OH} is the O—H distance, and r_{CN} is the C—N distance.

Another method of determining the secondary structure of a protein is STRIDE (Structural Identification). In STRIDE, the position of a hydrogen is estimated and then the secondary structure is determined using such information, and this method is different from DSSP in terms of the energy calculation equation which determines the presence or absence of a hydrogen bond. On the other hand, PROSS determines the secondary structure using dihedral angles of a backbone.

According to DEFINE and VoTAP, the secondary structure of a protein is defined using only information about the alpha carbon (Cα). DEFINE simply compares the distance between alpha carbons with the standard distance of an ideal secondary structure and thus the secondary structure is defined when the corresponding distance is equal to the standard distance. VoTAP defines the three-dimensional structure of Voronoi tessellation per amino acid of a protein thus determining the secondary structure using the state of contact surface between the three-dimensional structures.

The use of X-ray or electron microscopy (EM) of a very large protein to investigate the protein's structure mainly provides only the alpha carbon coordinates, and in the case of a protein having a known structure, only the alpha carbon coordinates among some amino acid coordinates are known. In this case, the presence or absence of a hydrogen bond has to be determined using only the alpha carbon coordinates to thereby identify the secondary structure of a protein. Compared to DSSP using all of the known atom coordinates, the above conventional methods have an accuracy of a little over 80%. In order to accurately determine the presence or absence of a hydrogen bond, the orientation of four atoms (H, N, C, O) of the hydrogen bond is very important, but is not easy based on only the alpha carbon coordinates. Thus there is a need for a method that is able to accurately determine the secondary structure of a protein using only the alpha carbon coordinates.

### DISCLOSURE

### Technical Problem

Therefore, an object of the present invention is to provide an apparatus and method for identifying the secondary structure of a protein using alpha carbon coordinates, in which the secondary structure of a protein only the alpha carbon coordinates of which are known may be identified with high accuracy.

Another object of the present invention is to provide a computer-readable storage medium which stores a program that may execute, on a computer, the method of identifying the secondary structure of a protein using alpha carbon coordinates, in which the secondary structure of a protein only the alpha carbon coordinates of which are known may be identified with high accuracy.

### Technical Solution

In order to accomplish the above objects, the present invention provides an apparatus for identifying the secondary structure of a protein using alpha carbon coordinates, comprising a pseudo center fixing unit configured to receive a series of alpha carbon coordinates included in amino acid sequences of a target protein so that pseudo centers corresponding to respective alpha carbons are disposed at positions fixed between the respective alpha carbons and alpha carbons adjacent thereto; a helix determination unit configured to determine, based on a dihedral angle and a distance between a preset number of consecutive pseudo centers among the pseudo centers fixed for the target protein, whether the secondary structure formed by a plurality of amino acids corresponding to the consecutive pseudo centers is a helix; and a strand determination unit configured to determine, based on distances between pseudo centers included in different pseudo center sequences in a plurality of pseudo center sequences comprising a preset number of consecutive pseudo centers among pseudo centers other than those corresponding to the helix, whether the secondary structure formed by a plurality of amino acids corresponding to the pseudo centers of respective pseudo center sequences is a strand.

In addition, the present invention provides a method of identifying the secondary structure of a protein using alpha carbon coordinates, comprising disposing pseudo centers corresponding to respective alpha carbons at positions fixed between the respective alpha carbons and alpha carbons adjacent thereto based on a series of alpha carbon coordinates included in amino acid sequences of a target protein; determining, based on a dihedral angle and a distance between a preset number of consecutive pseudo centers among the pseudo centers fixed for the target protein, whether the secondary structure formed by a plurality of amino acids corresponding to the consecutive pseudo centers is a helix; and determining, based on distances between pseudo centers included in different pseudo center sequences in a plurality of pseudo center sequences comprising a preset number of consecutive pseudo centers among pseudo centers other than those corresponding to the helix, whether the secondary structure formed by a plurality of amino acids corresponding to the pseudo centers of respective pseudo center sequences is a strand.

### Advantageous Effects

In an apparatus and method for identifying the secondary structure of a protein using alpha carbon coordinates according to the present invention, the secondary structure including amino acids corresponding to pseudo centers can be identified based on the dihedral angle or the distance between pseudo centers using pseudo centers fixed between alpha carbons instead of using the given alpha carbon coordinates in unchanged form. Thereby, even when only the alpha carbon coordinates are known for the amino acids of a protein, the secondary structure of a corresponding protein can be identified, thus increasing the accuracy compared to conventional methods using alpha carbon coordinates.

### DESCRIPTION OF DRAWINGS

FIG. 1 is a block diagram illustrating an apparatus for identifying the secondary structure of a protein using alpha carbon coordinates according to a preferred embodiment of the present invention;

FIG. 2 illustrates the primary structure of a protein;

FIG. 3 illustrates the backbone of an alpha helix;

FIG. 4 illustrates the alpha helix when viewed from above;

FIG. 5 illustrates the backbone of a 3/10 helix;

FIG. 6 illustrates the 3/10 helix when viewed from above;

FIG. 7 illustrates the backbone of a parallel strand;

FIG. 8 illustrates the backbone of an anti-parallel strand;

FIG. 9 is a graph illustrating the distance distribution between alpha carbons included in amino acids which form hydrogen bonds in the alpha helix;

FIG. 10 is a graph illustrating the distance distribution between pseudo centers fixed relative to respective alpha carbons in the alpha helix;

FIG. 11 illustrates the defining of pseudo centers from amino acid bonds in a protein;

FIG. 12 illustrates the secondary structure obtained using DSSP results of Nuclear Transport factor 2 in which the PDB (Protein Data Bank) ID is 1OUN;

FIG. 13 illustrates the residues within the range in which the distances between pseudo centers in the amino acid sequence of the protein of FIG. 11 are predetermined;

FIG. 14 illustrates the sequence of Nuclear Transport Factor 2 and the secondary structure defined by DSSP;

FIGS. 15 and 16 illustrate the hydrogen bonds in the alpha helix and the determination of the alpha helix using pseudo centers, respectively;

FIGS. 17 and 18 illustrate the hydrogen bonds in the 3/10 helix and the determination of the 3/10 helix using pseudo centers, respectively;

FIGS. 19 and 20 illustrate the hydrogen bonds in the parallel strand and the determination of the parallel strand using pseudo centers, respectively;

FIGS. 21 and 22 illustrate the hydrogen bonds in the anti-parallel strand and the determination of the anti-parallel strand using pseudo centers, respectively;

FIG. 23 illustrates the hydrogen bonding between the amino acid of the anti-parallel strand and another amino acid; and

FIG. 24 is a flowchart illustrating a process of identifying the secondary structure of a protein by means of the apparatus of the invention using alpha carbon coordinates according to a preferred embodiment of the present invention.

### MODE FOR INVENTION

Hereinafter, a detailed description will be given of an apparatus and method for identifying the secondary structure of a protein using alpha carbon coordinates according to preferred embodiments of the invention with reference to the appended drawings.

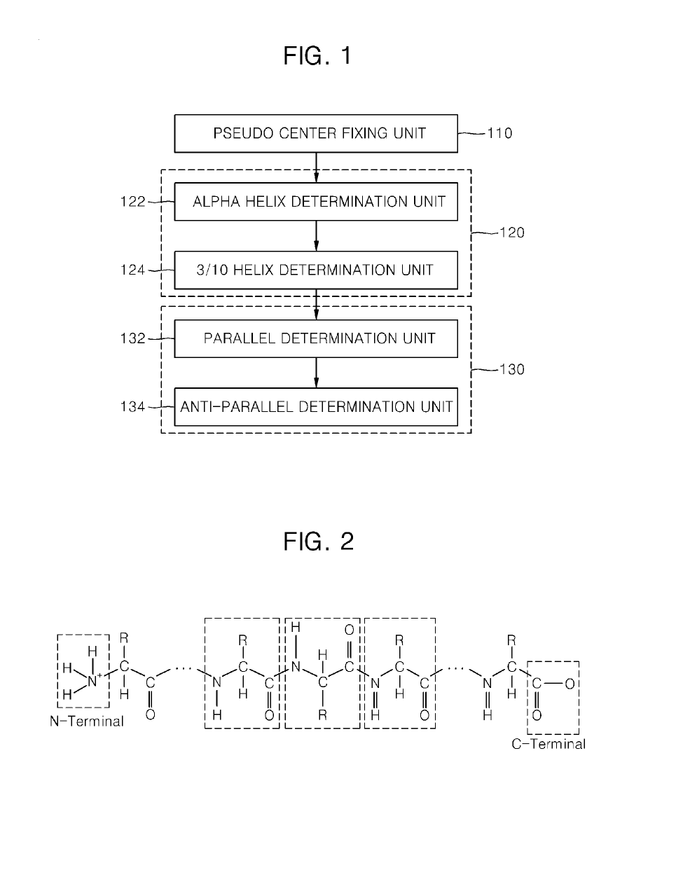

FIG. 1 is a block diagram illustrating an apparatus for identifying the secondary structure of a protein using alpha carbon coordinates according to a preferred embodiment of the present invention.

As illustrated in FIG. 1, the apparatus for identifying the secondary structure of a protein according to the present invention includes a pseudo center fixing unit 110, a helix determination unit 120 and a strand determination unit 130.

The secondary structure of a protein, which will be identified using the apparatus for identifying the secondary structure of a protein according to the present invention, is first described. Amino acids which are the building blocks of a protein have an amino group (N—H), a carbonyl group (C═O), a side chain (R), and alpha carbon (Cα). FIG. 2 illustrates the primary structure of a protein, in which the position of alpha carbons is shown in bold.

The secondary structure of a protein designates a structure in specific form via hydrogen bonding between the amino acids of a protein as illustrated in FIG. 2, in which the hydrogen bond is formed between the H of the amino group and the O of the carbonyl group. When such a hydrogen bond is shown in a predetermined pattern this is called the secondary structure. There are some kinds of secondary structure depending on the orientation and type of hydrogen bond, and typical examples thereof include the helix, strand, turn and random coil.

The helix may include an alpha helix and a 3/10 helix, and the strand may include a parallel strand and an anti-parallel strand. A small ring which connects two secondary structures is referred to as a turn, and the structure other than the above three types of secondary structure is a random coil. The ratio of secondary structures of known proteins is given in Table 1 below.

TABLE 1

| Kind of Secondary Structure | Ratio (%) |
|---|---|
| Helix | 38.01 |
| Strand | 16.98 |
| Turn | 0.38 |
| Random coil | 44.63 |

Table 2 below shows the kind and ratio of the helix defined and subdivided by DSSP.

TABLE 2

| Kind of Helix | Ratio (%) |
|---|---|
| Ring-handed alpha helix | 36.1178 |
| Ring-handed omega helix | 0.00024 |
| Ring-handed pi helix | 0.00130 |
| Ring-handed gamma helix | 0.00127 |
| Ring-handed 3/10 helix | 3.87257 |
| Left-handed alpha helix | 0.00065 |
| Left-handed omega helix | 0.00038 |
| Left-handed gamma helix | 0.00040 |
| 27 ribbon/helix | 0.00044 |
| polyproline helix | 0.00098 |

As is apparent from Table 2, the right-handed alpha helix and the right-handed 3/10 helix are very abundantly present in 36% and 3.8%, respectively, and the others are present to the extent of less than 0.001%.

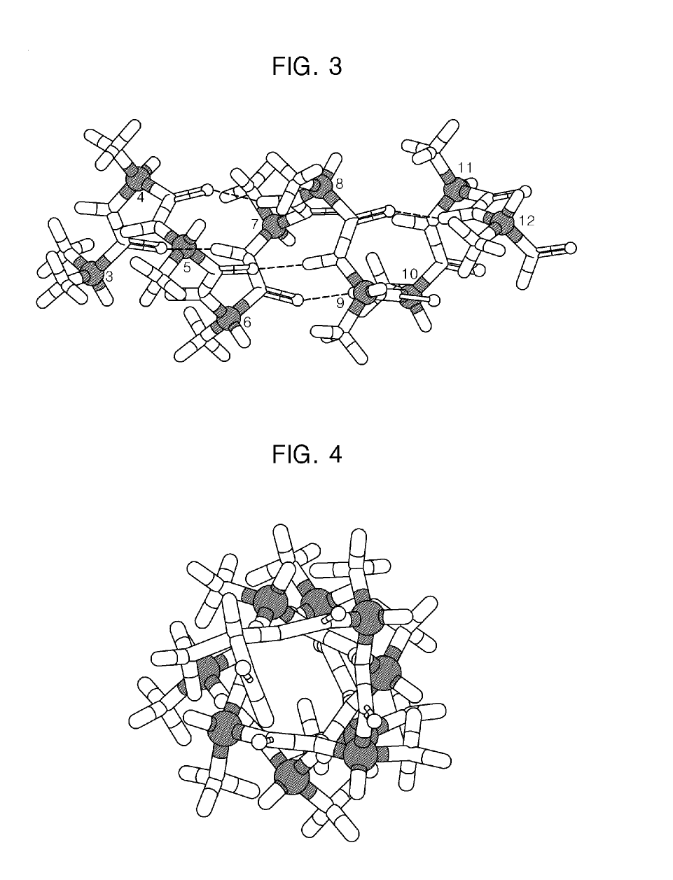

The alpha helix, which is very frequently the type of helix, includes hydrogen bonds between amino acids which are spaced apart from each other while three amino acids are interposed therebetween, and the four consecutive amino acids form a helical shape. FIG. 3 illustrates the backbone of the alpha helix. As illustrated in FIG. 3, oxygen (O) of the carbonyl group of the amino acid at position N (which is 5 in FIG. 3) and hydrogen (H) of the amino group of the amino acid at position N+4 (which is 9 in FIG. 3) can be seen to form a hydrogen bond (dotted line). The helical shape is formed via such bonds, and when 3.6 building blocks are involved per 360° rotation, the resulting structure is defined as an alpha helix.

FIG. 4 illustrates the alpha helix when viewed from above. In FIG. 4, the shady round atoms are alpha carbons. The angles between alpha carbons are about 100°, and the alpha helix is more stable than the 1/30 helix, so that the hydrogen bonds are consecutively formed longer, compared to the 3/10 helix.

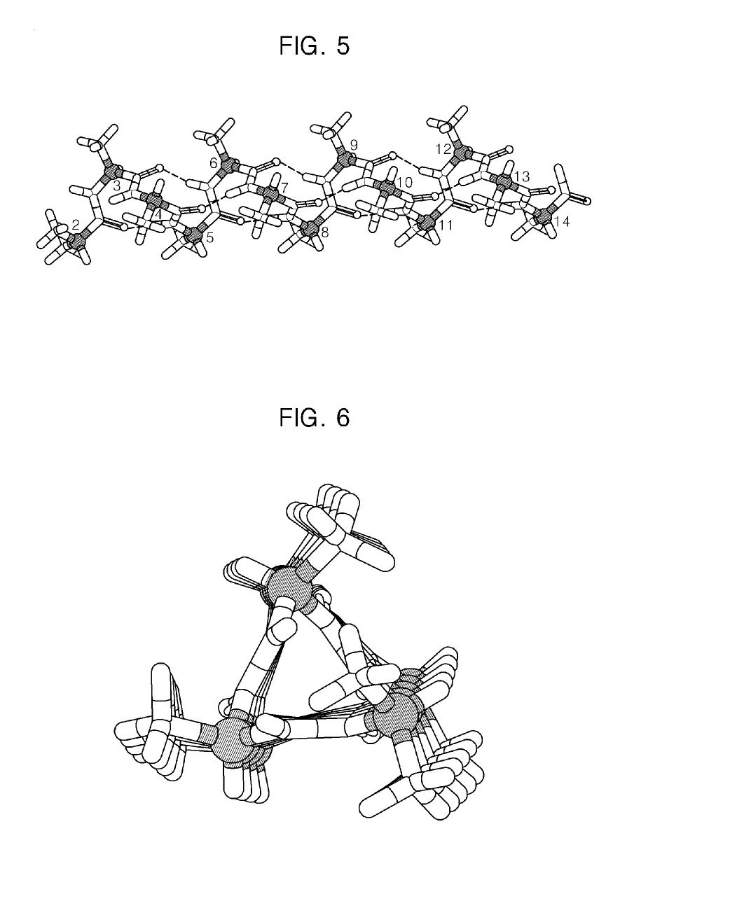

The 3/10 helix includes hydrogen bonds between amino acids which are spaced apart from each other while two amino acids are interposed therebetween, and the three consecutive amino acids form a helical shape. FIG. 5 illustrates the backbone of the 3/10 helix, in which oxygen (O) of the carbonyl group of the amino acid at position N (that is 6 in FIG. 5) and hydrogen (H) of the amino group of the amino acid at position N+3 (that is 9 in FIG. 5) can be seen to form a hydrogen bond (the dotted line). The helical shape is formed via such bonds, and when three amino acids are involved per rotation, the resulting structure is defined as a 3/10 helix.

FIG. 6 illustrates the 3/10 helix when viewed from above. In FIG. 6, the shady round atoms are alpha carbons. The angles between alpha carbons are about 120°, and the 3/10 helix is more unstable than the alpha helix but is very common.

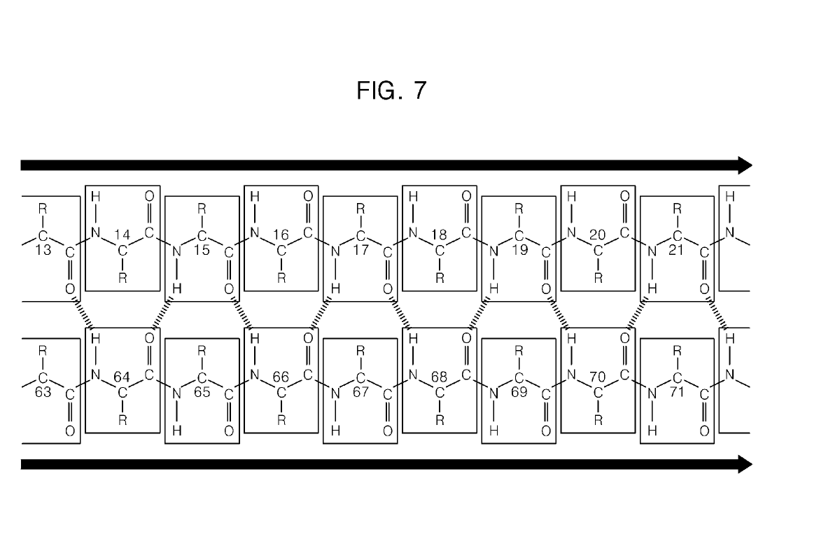

In addition, the strand which is another kind of secondary structure includes the parallel strand (which is referred to as “parallel”) and the anti-parallel strand (which is referred to as “anti-parallel”). FIG. 7 illustrates the backbone of the parallel strand. As illustrated in FIG. 7, carbon atoms (C) written together with numerals indicate alpha carbons, and the numerals written at alpha carbons indicate building block Nos. Furthermore, respective rectangular boxes indicate a single amino acid. The direction of the arrow in FIG. 7 shows the direction of the amino acid sequence, and in the case of the parallel strand, hydrogen bonds (the dotted line) are formed in the same direction along two amino acid sequences. Also in the parallel strand, oxygen (O) of the carbonyl group and hydrogen (H) of the amino group (e.g. at position 17) are not bound to the amino acid (at position 67) which is located opposite thereto, but are bound to oxygen (O) of the carbonyl group of the left amino acid (at position 66) and hydrogen (H) of the amino group of the right amino acid (at position 68) to form hydrogen bonds. The case where the hydrogen bonds are formed in this way is referred to as a parallel strand.

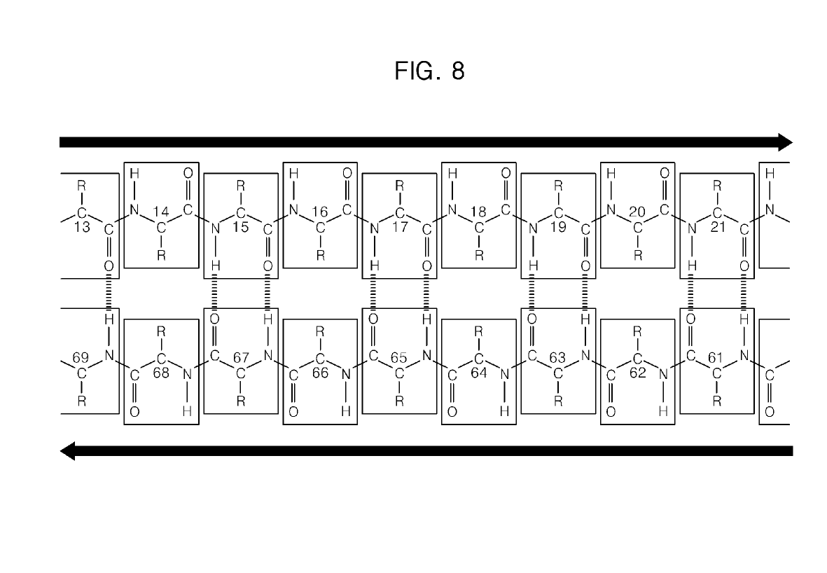

FIG. 8 illustrates the backbone of the anti-parallel strand. The direction of the arrow in FIG. 8 is the direction of the amino acid sequence, and two amino acid sequences are arranged in opposite directions to form hydrogen bonds, unlike the parallel strand. For example, oxygen (O) of the carbonyl group and hydrogen (H) of the amino group of the amino acid at position 17 are bound to oxygen (O) of the carbonyl group and hydrogen (H) of the amino group of the amino acid at position 65 which is located opposite thereto, thus forming hydrogen bonds, and amino acids (at positions 16 and 18) located at both sides of the amino acid at position 17 do not form hydrogen bonds.

Although the secondary structure such as a turn is present in addition to the helix and the strand, its ratio of appearance is very small and it is mostly handled like a random coil, and hereinafter in the present invention the turn will be regarded as a random coil.

In order to identify the secondary structure of a given protein as mentioned above, that is, a helix including the alpha helix and the 3/10 helix and a strand including the parallel strand and the anti-parallel strand, the apparatus according to the present invention uses alpha carbon coordinates of the target protein in lieu of hydrogen bond energy. Also, the alpha carbon coordinates are not used unchanged but pseudo centers which are newly disposed between alpha carbons are used.

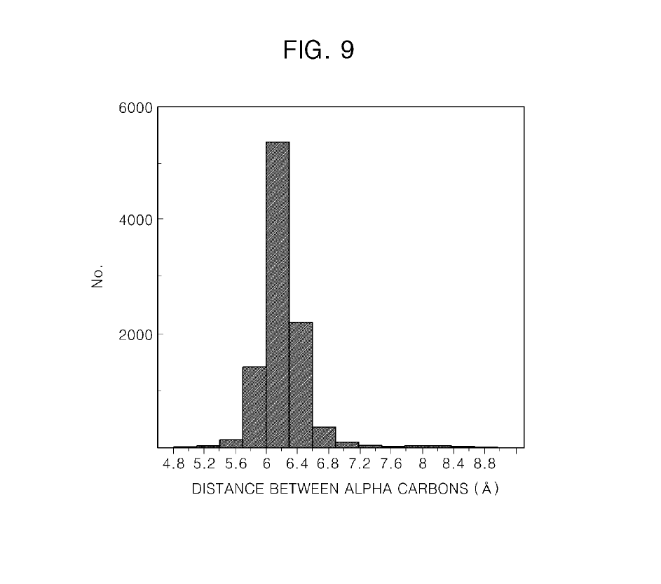

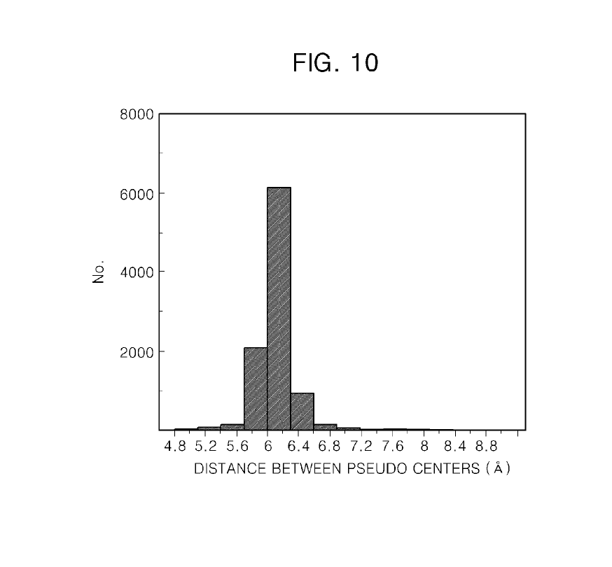

FIGS. 9 and 10 are graphs illustrating the distance distribution between alpha carbons included in amino acids which form hydrogen bonds in the alpha helix and the distance distribution between pseudo centers fixed relative to respective alpha carbons. In the graphs of FIGS. 9 and 10, the transverse axis is the distance between alpha carbons and the distance between pseudo centers, and the longitudinal axis is the number of amino acids which form the hydrogen bonds at the corresponding distance. As illustrated in FIG. 9, the standard deviation when using alpha carbons is 0.32, and in FIG. 10, the standard deviation when using pseudo centers is 0.27, from which better results can be seen to be obtained when using pseudo centers than when using alpha carbons. This is because hydrogen bonds are formed at locations closer to pseudo centers which are at central positions between two alpha carbons adjacent to each other, not near the alpha carbons.

In order to use the pseudo centers to identify the secondary structure of a protein, the pseudo center fixing unit 110 receives a series of alpha carbon coordinates included in the amino acid sequences of a target protein so that pseudo centers corresponding to respective alpha carbons are disposed at positions fixed between respective alpha carbons and alpha carbons adjacent thereto.

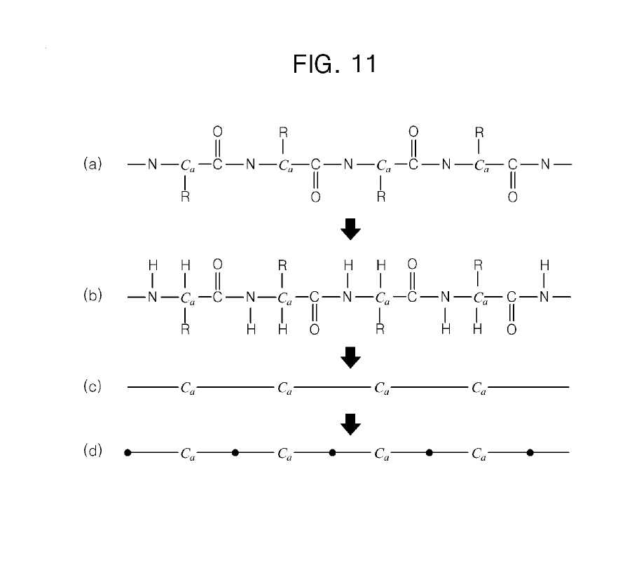

FIG. 11 illustrates the defining of pseudo centers from the amino acid bonds of a protein. As illustrated in FIG. 11, (a) one-dimensionally illustrates the amino acid bonds of a protein. In the case of a protein whose structure is determined using X-ray or NMR, as shown in (a) of FIG. 11, information about heavy atoms, namely, atoms of amino acids except for hydrogen, is given. If NMR is used, the position of the hydrogen is also determined. Even when the structure of a protein is not determined using NMR, the position of the hydrogen may be estimated as shown in (b) of FIG. 11 using information about heavy atoms.

As illustrated in (b) of FIG. 11, when the hydrogen coordinates of heavy atoms are obtained, the hydrogen bond energy is calculated using Equation 1. The case where the energy is less than −0.5 Kcal/mol is defined as the hydrogen bond and then the secondary structure is judged according to the conventional DSSP.

However, in some cases where EM or X-rays are used, as illustrated in (c) of FIG. 11, only the alpha carbon coordinates are given. In conventional research, attempts have been made to directly use such alpha carbons in order to estimate the secondary structure of a protein, but the position of alpha carbons is distant from the positions of N—H and C═O which are actually used to form a hydrogen bond, compared to the pseudo centers, making it difficult to perform accurate identification. Thus, in the apparatus for identifying the secondary structure of a protein according to the present invention, defining pseudo centers between alpha carbons and determining the presence or absence of a hydrogen bond using the distance between the pseudo centers are applied.

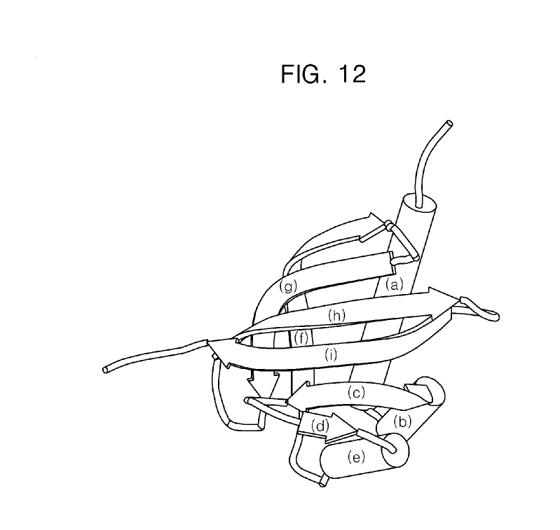

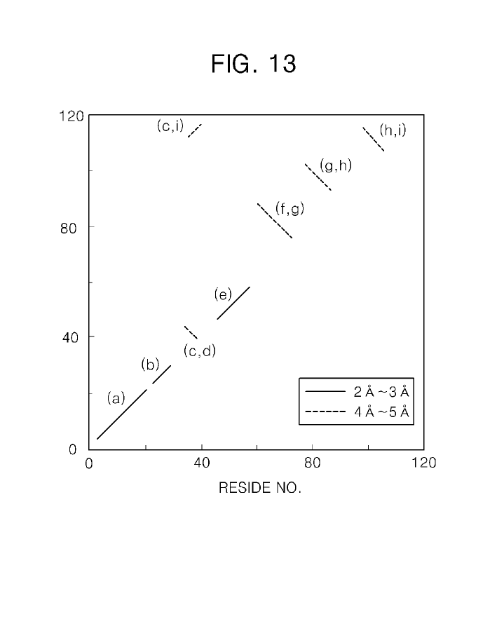

FIG. 12 illustrates the secondary structure obtained using DSSP results of Nuclear Transport factor 2 in which the PDB (Protein Data Bank) ID is 1OUN. In FIG. 12, the cylinder exhibits a helix, and the arrow indicates a strand. FIG. 13 illustrates residues within the distance range in which the distances between pseudo centers in the amino acid sequence of the protein of FIG. 12 are predetermined, in which the straight lines are the case where the distance falls in the range of 2˜3 and the dotted lines are the case where the distance falls in the range of 4˜5. The graph of FIG. 13 shows only the case where at least four or more residues satisfying the distance conditions are consecutive. Even when one break is present therebetween, the case where four or more residues are consecutive is included in FIG. 13. The straight line of FIG. 13 designates the strand of FIG. 12, and the strand requires a match which makes a pair and thus two letters are shown together in the straight line graph of FIG. 13.

As is apparent from FIG. 13, it can be seen that (a), (b) and (e), which are diagonally positioned in the graph and are not distant from the center, form the helix, and (c,d), (f,g), (g,h) and (h,i), which are anti-diagonally positioned in the graph while being positioned near the center of the diagonal line, form an anti-parallel strand in which the connection loop is not long, and (c,i), which is diagonally positioned in the graph but is distant away from the center of the diagonal line, forms a parallel strand in which the connection loop is long.

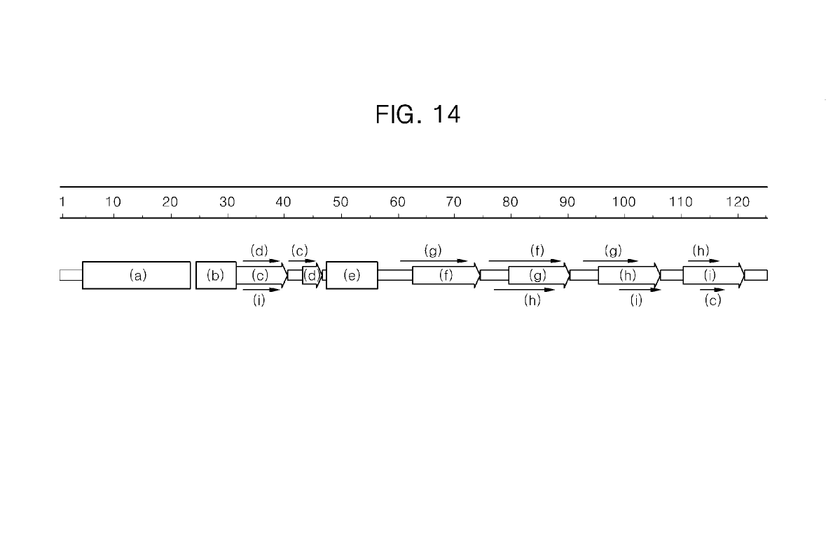

FIG. 14 illustrates the sequence of Nuclear Transport Factor 2 and the secondary structure defined by DSSP. The letters marked in respective sequences in FIG. 14 correspond to the positions of respective sequences of FIG. 13, and the letters given above and below the sequence in arrow form indicate the strand which forms the hydrogen bond with the corresponding sequence. As illustrated in FIG. 14, even when the secondary structure is identified using the distance between pseudo centers, results similar to those obtained when using DSSP can be gotten.

Below, a method of identifying the secondary structure of a target protein is described in detail using the pseudo centers corresponding to respective alpha carbons by the pseudo center fixing unit 110.

The helix determination unit 120 is configured such that pseudo centers fixed for the target protein are classified into a plurality of groups comprising the preset number of consecutive pseudo centers, and whether the secondary structure formed by a plurality of amino acids corresponding to the pseudo centers of respective groups is a helix is determined based on the dihedral angle and the distance between the pseudo centers of respective groups.

As mentioned above, the helix includes an alpha helix and a 3/10 helix, and thus the helix determination unit 120 includes an alpha helix determination unit 122 and a 3/10 helix determination unit 124.

The alpha helix determination unit 122 is configured such that the secondary structure formed by the amino acid sequence corresponding to four pseudo centers is determined to be an alpha helix under conditions in which the distance between the first and fourth pseudo centers in four consecutive pseudo centers among the pseudo centers falls in the preset first distance range and the dihedral angle defined by the four pseudo centers falls in the preset first angle range.

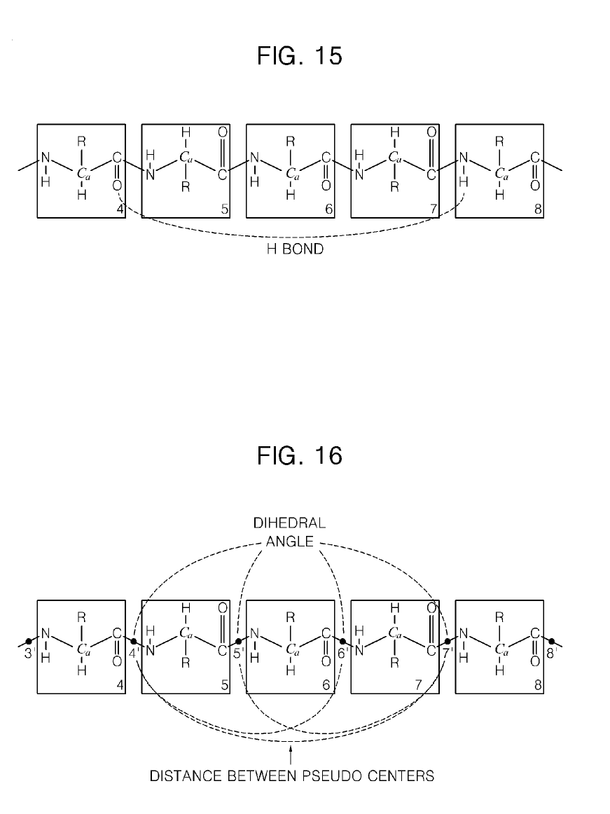

FIGS. 15 and 16 illustrate the hydrogen bonds in the alpha helix and the determination of the alpha helix using the pseudo centers. As illustrated in FIG. 15, the alpha helix includes the hydrogen bond between the oxygen (O) of the carbonyl group of the amino acid at position N (which is 4 in FIG. 15) and hydrogen (H) of the amino group of the amino acid at position N+4 (which is 8 in FIG. 15). As such, because it is difficult to determine whether the hydrogen bond is present using only the position of the alpha carbon, as shown in FIG. 16, whether the distance between the pseudo center at position N′ (which is 4′ in FIG. 16) and the pseudo center at position N+3 (which is 7′ in FIG. 16) falls in the preset first distance range is checked. Herein, the pseudo center's number depends on the amino acid's number which is located just before in the direction of the amino acid sequence.

Even when the distance between the pseudo center at position N and the pseudo center at position N+3 falls in the first distance range, if the directions of oxygen and hydrogen are inappropriate, the hydrogen bond is not formed. Hence, the dihedral angle must be known to estimate the direction of hydrogen. The dihedral angle is an angle defined by four points, which are pseudo centers at positions N, N+1, N+2 and N+3. If the dihedral angle falls in the preset first angle range, the given sequence is judged to be an alpha helix. For example, when the distance between the pseudo center at position N and the pseudo center at position N+3 falls in the first distance range of 4.21˜5.23 and the dihedral angle defined by the pseudo centers at positions N, N+1, N+2 and N+3 falls in the first angle range of 43.52˜78.32°, four consecutive amino acids at positions N to N+3 are determined to form the alpha helix.

On the other hand, in the case of proline among amino acids, oxygen (O) of the carbonyl group may form the hydrogen bond with another amino acid, but the amino group has no hydrogen (H) and thus it does not form the hydrogen bond with another amino acid, unlike the other 19 kinds of amino acids. Accordingly, in the case of proline, even when the dihedral angle and the distance between pseudo centers satisfy the preset ranges and thus the hydrogen bond is judged to be formed, the hydrogen bond cannot be actually formed and is not included in the bond.

Conclusively, determining whether the hydrogen bond is present or not is repeated, after which if such bonds are consecutively present, the secondary structure of a given protein is defined as an alpha helix.

The 3/10 helix determination unit 124 is configured such that the secondary structure formed by the amino acid sequence corresponding to four pseudo centers is determined to be a 3/10 helix under conditions in which, in the four consecutive pseudo centers, the distance between the first and third pseudo centers, the distance between the second and fourth pseudo centers and the distance between the first and fourth pseudo centers respectively fall in the preset second, third and fourth distance ranges, and the dihedral angle defined by the four pseudo centers falls in the preset second distance range.

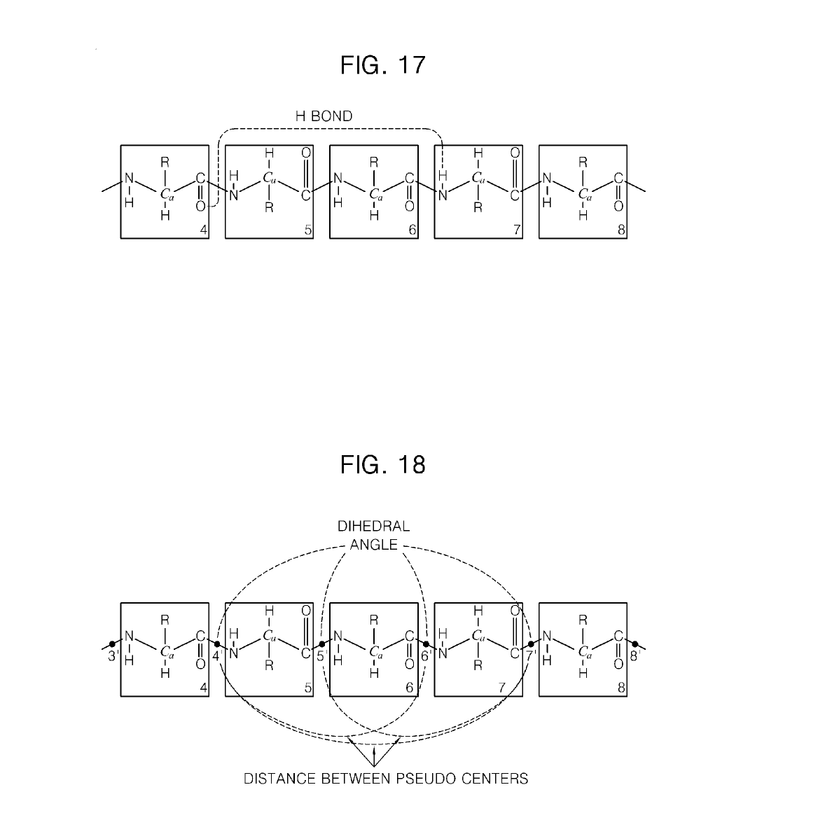

FIGS. 17 and 18 illustrate the hydrogen bonds in the 3/10 helix and the determination of the 3/10 helix using the pseudo centers. As illustrated in FIG. 17, the ideal 3/10 helix includes the hydrogen bond between oxygen (O) of the carbonyl group of the amino acid at position N (which is 4 in FIG. 15a) and hydrogen (H) of the amino group of the amino acid at position N+3 (which is 7 in FIG. 15a). When this is shown using the pseudo centers of FIG. 18, oxygen (O) of the carbonyl group of the amino acid at position N (which is 4 in FIG. 17) is represented by the pseudo center at position N (which is 4′ in FIG. 18) and hydrogen (H) of the amino group of the amino acid at position N+2 (which is 6 in FIG. 17) is represented by the pseudo center at position N+2 (which is 6′ in FIG. 18).

As in the alpha helix, even when the distance between pseudo centers at positions N and N+2 falls in the preset distance range, it still has to be checked whether the directions of oxygen (O) and hydrogen (H) are appropriate to form the hydrogen bond using the dihedral angle. In the alpha helix, because pseudo centers which form the hydrogen bond are spaced apart from each other between which three pseudo centers are interposed, the dihedral angle is calculated using the pseudo centers at both ends forming the hydrogen bond and the pseudo centers (N, N+1, N+2, N+3) therebetween. However, in the case of the 3/10 helix, pseudo centers which form the hydrogen bond are spaced apart from each other between which two pseudo centers are interposed, and thus upon calculating the dihedral angle, the pseudo center at position N+3 (which is 7′ in FIG. 18) is additionally included, so that the dihedral angle is calculated using four consecutive pseudo centers.

As the pseudo center at position N+3 is additionally included, the 3/10 helix determination unit 124 uses, as the additional determination conditions, the distance between the pseudo center at position N+1 (which is 5′ in FIG. 18) and the pseudo center at position N+3 (which is 7′ in FIG. 18) and the distance between the pseudo center at position N (which is 4′ in FIG. 18) and the pseudo center at position N+3 (which is 7′ in FIG. 18). That is, one dihedral angle and three distances between pseudo centers are used as the conditions for determining the secondary structure.

In the most preferred embodiment, the secondary structure formed by the amino acid sequence corresponding to four pseudo centers at positions N to N+3 may be determined to be a 3/10 helix under conditions in which the distance between the pseudo center at position N and the pseudo center at position N+2 falls in the second distance range of within 4.82, the distance between the pseudo center at position N+1 and the pseudo center at position N+3 falls in the third distance range of within 5.24, the distance between the pseudo center at position N and the pseudo center at position N+3 falls in the fourth distance range of 5.14˜9.12, and the dihedral angle defined by the pseudo centers at positions N, N+1, N+2 and N+3 falls in the second angle range of 42.1˜119.5°.

After determining whether the secondary structure is a helix using the pseudo centers fixed for the target protein, it is determined whether pseudo centers other than those corresponding to the helix correspond to a strand.

The strand determination unit 130 is configured such that, based on distances between pseudo centers included in different pseudo center sequences in a plurality of pseudo center sequences comprising the preset number of consecutive pseudo centers among pseudo centers other than those corresponding to the helix, whether the secondary structure formed by a plurality of amino acids corresponding to the pseudo centers of respective pseudo center sequences is a strand is determined.

In the secondary structure of the protein as mentioned above, the strand includes a parallel strand and an anti-parallel strand, and thus the strand determination unit 130 includes a parallel determination unit 132 and an anti-parallel determination unit 134.

The parallel determination unit 132 is configured such that, under conditions in which the distance between pseudo centers respectively included in different pseudo center sequences proceeding in the same direction falls in the preset fifth distance range and the distance between consecutive pseudo centers of the pseudo centers respectively included in the different pseudo center sequences falls in the preset sixth distance range, the secondary structure formed by the amino acid sequences corresponding to the different pseudo center sequences is determined to be a parallel strand.

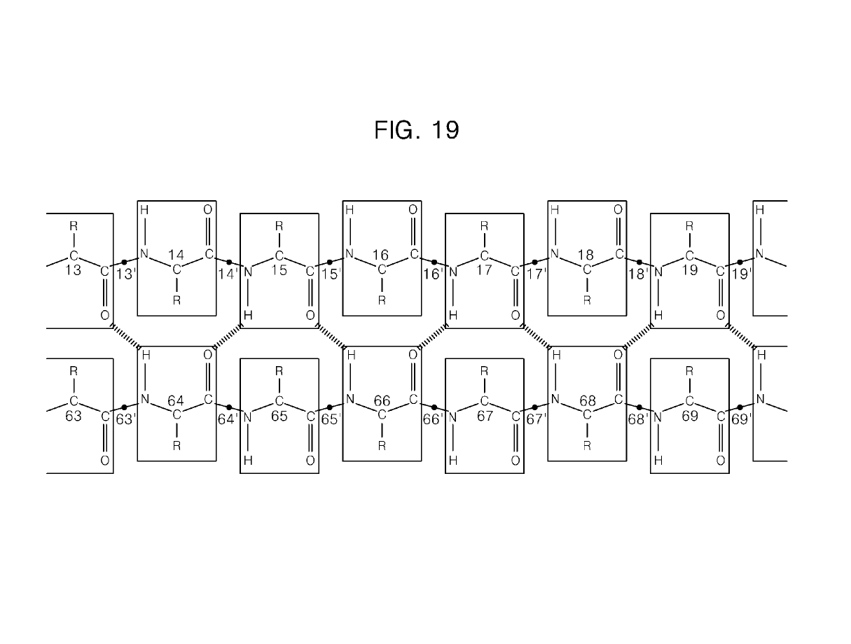

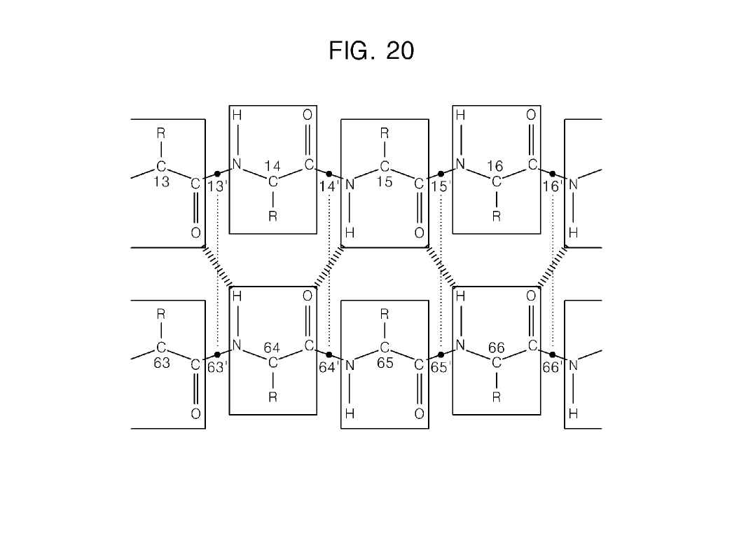

FIGS. 19 and 20 illustrate the hydrogen bonds in the parallel stand and the determination of the parallel strand using the pseudo centers. As illustrated in FIG. 19, hydrogen bonds between amino acid sequences of the same direction with the parallel structure are formed by binding both hydrogen (H) of the amino group and oxygen (O) of the carbonyl group of the amino acid included in one amino acid sequence with hydrogen (H) of the amino group and oxygen (O) of the carbonyl group of the amino acids of the other amino acid sequence. Also, in the case where the amino acid at position N (which is 15 in FIG. 19) forms the hydrogen bond, the amino acid at position N−1 (which is 14 in FIG. 19) and the amino acid at position N+1 (which is 16 in FIG. 19) do not form a hydrogen bond.

In order to identify the secondary structure of a given protein, as illustrated in FIG. 20, with relation to the pseudo center sequences corresponding to the amino acid sequences forming the parallel strand, it is examined whether the distance between pseudo centers continuously falls in the predetermined range. For example, in FIG. 20, the parallel strand is identified as having been formed under conditions in which the distance between the pseudo center at position N (which is 14′ in FIG. 20) and the pseudo center at position M (which is 64′ in FIG. 20) in different pseudo center sequences falls in the fifth distance range of 2.58˜5.18, and the distance between the pseudo center at position N−1 (which is 13′ in FIG. 20) and the pseudo center at position M−1 (which is 63′ in FIG. 20) falls in the sixth distance range of 4.34˜5.03. As such, the difference between N and M is preferably 5 or more.

The anti-parallel determination unit 134 is configured such that, under conditions in which the distance between pseudo centers respectively included in different pseudo center sequences proceeding in the opposite directions falls in the preset seventh distance range, the distance between consecutive pseudo centers of the pseudo centers respectively included in the different pseudo center sequences falls in the preset eighth distance range, and the distance between alpha carbons respectively corresponding to the pseudo centers respectively included in the difference pseudo center sequences falls in the preset ninth distance range, the secondary structure formed by the amino acid sequences corresponding to the different pseudo center sequences is determined to be an anti-parallel strand.

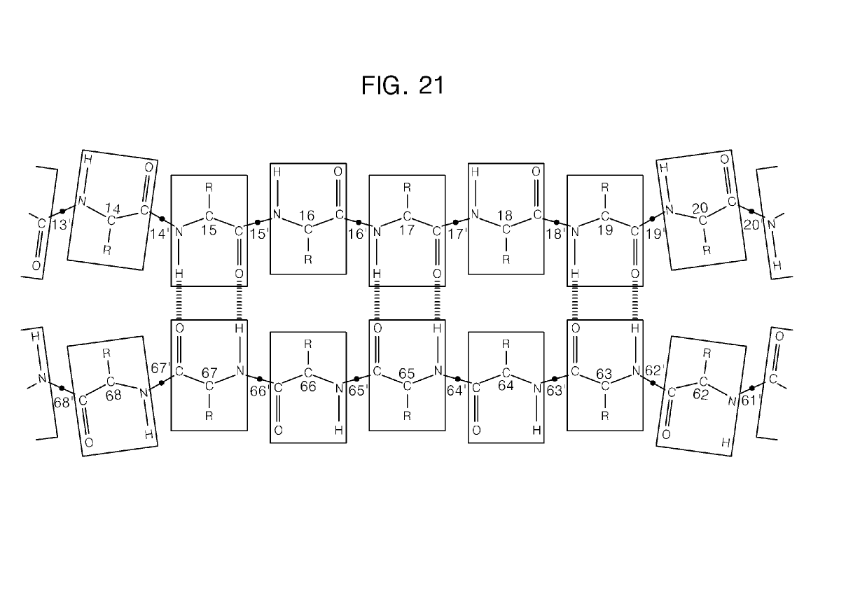

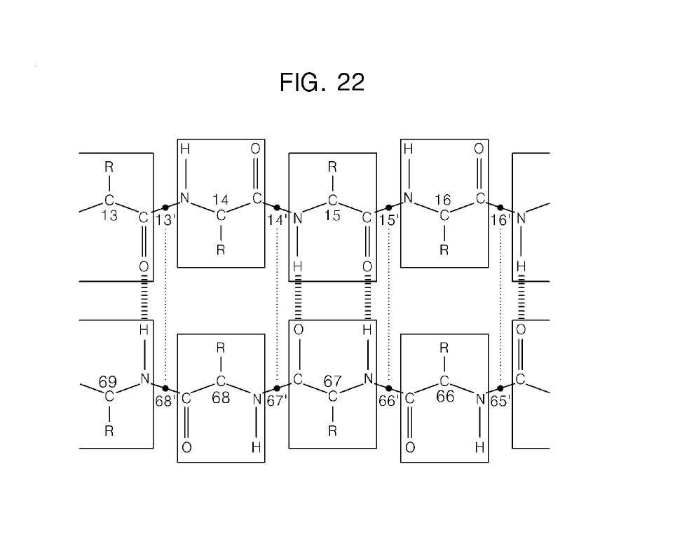

FIGS. 21 and 22 illustrate the hydrogen bonds in the anti-parallel stand and the determination of the anti-parallel strand using the pseudo centers. As illustrated in FIG. 21, hydrogen bonds between amino acid sequences which form the anti-parallel strand are formed by binding both hydrogen (H) of the amino group and oxygen (O) of the carbonyl group of the amino acid included in one amino acid sequence with hydrogen (H) of the amino group and oxygen (O) of the carbonyl group of the amino acid of the other amino acid sequence which is located opposite thereto. Also, in the case where the amino acid at position N (which is 15 in FIG. 21) forms a hydrogen bond, the amino acid at position N−1 (which is 14 in FIG. 21) and the amino acid at position N+1 (which is 16 in FIG. 21) do not form a hydrogen bond.

FIG. 22 illustrates the pseudo centers of the anti-parallel strand. As in the parallel strand, when two pairs of consecutive pseudo centers fall in the preset distance ranges, the secondary structure of a given protein is determined to be that of an anti-parallel strand. As such, in the case of the anti-parallel strand, the distance between alpha carbons is used, unlike the parallel strand. Specifically, the hydrogen bonds are determined to belong to the anti-parallel strand under conditions in which the distance between the pseudo center at position N (which is 15′ in FIG. 22) and the pseudo center at position M (which is 66′ in FIG. 22) falls in the seventh distance range of 4.36˜5.19, and the distance between the pseudo center at position N+1 (which is 16′ in FIG. 22) and the pseudo center at position M−1 (which is 65′ in FIG. 22) falls in the eighth distance range of 4.16˜5.27, and the distance between the alpha carbon at position N+1 (which is 16 in FIG. 22) and the alpha carbon at position M (which is 66 in FIG. 22) falls in the ninth distance range of 1.42˜5.99. Thus, the secondary structure formed by the amino acids at positions N, N+1, M−1 and M becomes an anti-parallel structure.

In the case when the above conditions in the anti-parallel strand, particularly pieces of information about the distances between pseudo centers and between alpha carbons are used, the accuracy is high in the middle portion of the amino acid sequence but relatively lower at the ends of the sequence. Thus, in the case of amino acids located at ends of the amino acid sequence, the amino acids associated with hydrogen bonds have to be discriminated from the amino acids that are not associated with hydrogen bonds. Specifically, in the case of the front end of the amino acid sequence in FIG. 21, the amino acids at positions 15 and 67 form hydrogen bonds, and thus whether the bonds are included in the anti-parallel strand may be easily determined based on the distance between pseudo centers at both sides thereof. However, because the amino acids at positions 14 and 68 do not directly form the hydrogen bonds, whether they are included in the anti-parallel strand may be determined depending on whether amino acids at positions 13 and 69 form the hydrogen bonds. As such, because it is difficult to directly judge the presence of hydrogen bond, the case where the distance between alpha carbons at positions 13 and 69 falls in the range of 3.00˜6.70 or where the distance between pseudo centers at positions 13′ and 68′ does not fall within 5.64 is not defined as an anti-parallel strand.

In the case of the ends (amino acids at positions 20 and 62) of FIG. 22, when the distance between alpha carbons at positions 21 and 61 falls in the range of 4.427˜6.40 or the distance between pseudo centers at positions 20′ and 61′ does not fall within 6.26, these amino acids are regarded as those which do not form hydrogen bonds. This case is not defined as the anti-parallel strand.

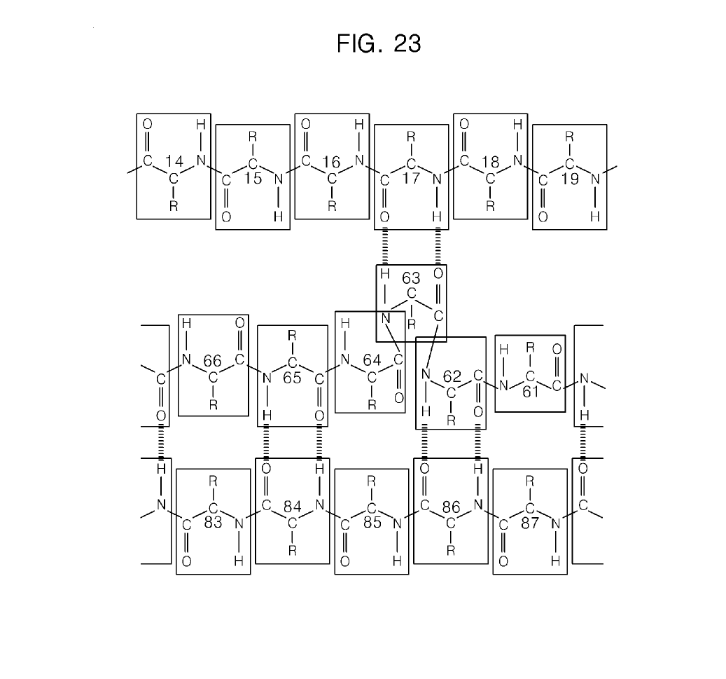

In two amino acid sequences forming the anti-parallel strand, any one amino acid may form the hydrogen bond with another amino acid included in the third amino acid sequence. FIG. 23 illustrates the formation of the hydrogen bond between the amino acid of the anti-parallel strand and another amino acid. As illustrated in FIG. 23, although the amino acid at position 63 is provided in the anti-parallel strand, it forms a hydrogen bond with another amino acid, that is, the amino acid at position 17. When one amino acid the of the anti-parallel strand forms a hydrogen bond with an amino acid of another strand in this way, the structure including the corresponding amino acid may be determined to be an anti-parallel structure.

Finally, the secondary structure of a protein, which does not correspond to the above four kinds of secondary structure (alpha helix, 3/10 helix, parallel strand and anti-parallel strand) is identified to be that of a random coil.

On the other hand, in the case of a helix, building blocks in which the distance between pseudo centers falls in the predetermined range may mainly correspond to a 1:1 ratio. Even if they correspond to a 1:2 ratio, a predetermined pattern of N+3 or N+4 should be formed to make the helix, and thus building blocks forming the hydrogen bonds may be estimated. In the case of a strand, it is provided in parallel form as in (h) of FIG. 12, or may be present in bent form as in (g) of FIG. 12. The strand may be slightly distorted at its bent portion, whereby there may occur cases in which the distance between pseudo centers does not fall in the predetermined range and the building blocks may correspond to a 1:2 or 1:3 ratio.

Because one building block forms a hydrogen bond with another building block, when they correspond to a 1:2 ratio or more, any one is selected from among building blocks at a 1:2 ratio using information about the building blocks corresponding to a 1:1 ratio. For example, when the distance between building blocks at positions 10 and 30 falls in the preset range and all of the distances between the building blocks at positions 11 and 30, 31 and 32 fall in the preset ranges, the building blocks at positions 11 and 31 may be set so that they form the hydrogen bond based on the building blocks at positions 10 and 30 at a 1:1 ratio.

The apparatus for identifying the secondary structure of a protein according to the present invention and doing the same using DSSP were used on pre-established 183 protein data and the accuracies thereof are compared. The results are shown in Table 3 below.

TABLE 3

| | Accuracy (%) of the | Accuracy (%) of DSSP |
|---|---|---|
| | Invention based on DSSP | based on the Invention |
| Helix | 94.51 | 93.56 |
| Strand | 89.13 | 88.44 |
| Random coil | 89.13 | 90.09 |
| Average | 90.91 | 90.91 |

As is apparent from Table 3, the accuracy of the invention based on DSSP is 90.91%, which is higher than the 83.2% which is the highest when using conventional methods depending on alpha carbon coordinates.

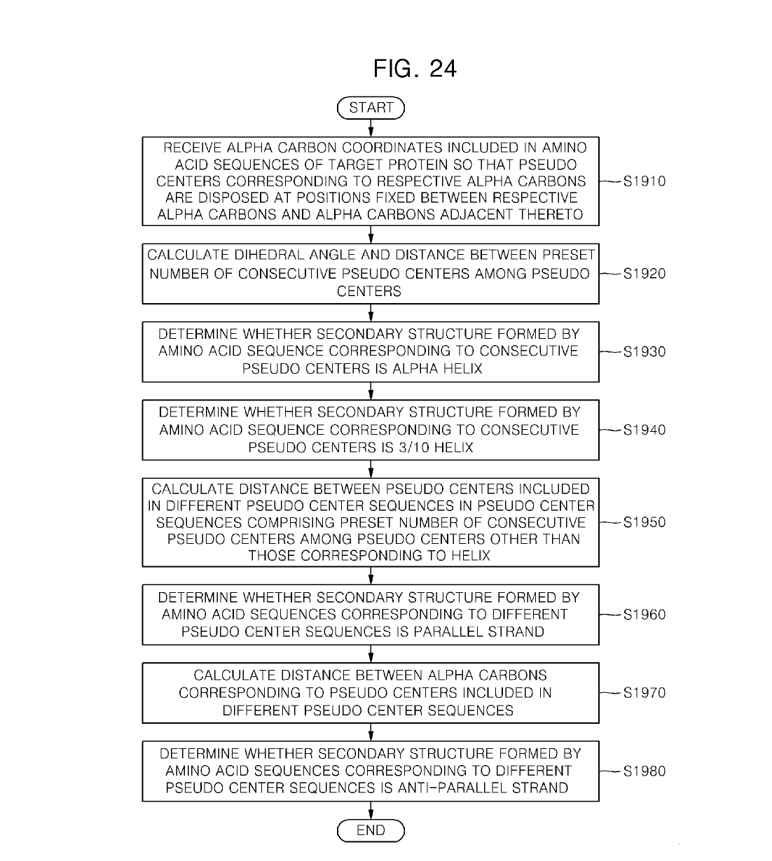

FIG. 24 is a flowchart illustrating a process of identifying the secondary structure of a protein by means of the above apparatus of the invention using alpha carbon coordinates.

As illustrated in FIG. 24, the pseudo center fixing unit 110 receives a series of alpha carbon coordinates of the amino acid sequences of a target protein, so that pseudo centers corresponding to respective alpha carbons are disposed at positions fixed between the respective alpha carbons and alpha carbons adjacent thereto at step S1910.

Next, the helix determination unit 120 determines whether the amino acid sequence corresponding to consecutive pseudo centers forms the helix depending on the dihedral angle and the distance between the preset number of consecutive pseudo centers among the pseudo centers fixed for the target protein at step S1920. As such, the alpha helix determination unit 122 determines that the secondary structure formed by the amino acid sequence corresponding to four pseudo centers is a alpha helix under conditions in which, in the four consecutive pseudo centers, the distance between the first and fourth pseudo centers falls in the preset first distance range and the dihedral angle formed by the four pseudo centers falls in the preset first angle range at step S1930.

The 3/10 helix determination unit 124 determines that the secondary structure formed by the amino acid sequence corresponding to four pseudo centers is a 3/10 helix. This determination is made at step S1940 because of the conditions that, in the four consecutive pseudo centers, the distance between the first and third pseudo centers, the distance between the second and fourth pseudo centers and the distance between the first and fourth pseudo centers respectively fall in the preset second, third and fourth distance ranges and the dihedral angle formed by the four pseudo centers falls in the preset second distance range.

The strand determination unit 130 calculates the distances between pseudo centers included in different pseudo center sequences in a plurality of pseudo center sequences comprising the preset number of consecutive pseudo centers among pseudo centers other than those corresponding to the helix. The distances between pseudo centers are calculated to determine whether the corresponding structure is a strand at step 1950. To this end, the parallel determination unit 132 determines that, under conditions in which the distance between pseudo centers included in different pseudo center sequences proceeding in the same direction falls in the preset fifth distance range and the distance between consecutive pseudo centers of the pseudo centers included in the different pseudo center sequences falls in the preset sixth distance range, the secondary structure formed by the amino acid sequences corresponding to the different pseudo center sequences is regarded as a parallel strand at step S1960.

The anti-parallel determination unit 134 calculates the distance between alpha carbons respectively corresponding to pseudo centers included in different pseudo center sequences as the additional determination condition at step S1970. This unit 134 determines that the conditions are such that the distance between pseudo centers included in different pseudo center sequences proceeding in the opposite directions falls in the preset seventh distance range, the distance between consecutive pseudo centers of the pseudo centers included in the different pseudo center sequences falls in the preset eighth distance range, and the distance between alpha carbons respectively corresponding to the pseudo centers included in the different pseudo center sequences falls in the preset ninth distance range. As a result of these determinations, the secondary structure formed by the amino acid sequences corresponding to the different pseudo center sequences is determined to be an anti-parallel strand at step 1980.

The present invention may be implemented in the form of computer-readable code that is stored in a computer-readable storage medium. The computer-readable storage medium includes all types of storage devices in which computer system-readable data can be stored. Examples of the computer-readable storage medium are ROM (Read Only Memory), RAM (Random Access Memory), CD-ROM (Compact Disk-Read Only Memory), magnetic tape, a floppy disk, an optical data storage device, etc. Furthermore, the computer-readable storage medium may be implemented in the form of carrier waves (e.g. in the case of transmission via the Internet). Moreover, the computer-readable storage medium may be distributed across computer systems connected via a network, and may be configured such that computer-readable code is stored and executed in a distributed manner.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An apparatus for identifying a secondary structure of a protein, comprising:
a pseudo center fixing unit configured to receive a series of alpha carbon coordinates included in amino acid sequences of a target protein so that pseudo centers corresponding to respective alpha carbons are disposed at positions fixed between the respective alpha carbons and alpha carbons adjacent thereto;
a helix determination unit configured to determine, based on a dihedral angle and a distance between a preset number of consecutive pseudo centers among the pseudo centers fixed for the target protein, whether the secondary structure formed by a plurality of amino acids corresponding to the consecutive pseudo centers is a helix; and
a strand determination unit configured to determine, based on distances between pseudo centers included in different pseudo center sequences in a plurality of pseudo center sequences comprising a preset number of consecutive pseudo centers among pseudo centers other than those corresponding to the helix, whether the secondary structure formed by a plurality of amino acids corresponding to the pseudo centers of respective pseudo center sequences is a strand.

2. The apparatus of claim 1, wherein the helix determination unit comprises:
an alpha helix determination unit configured such that, under conditions in which a distance between first and fourth pseudo centers in four consecutive pseudo centers among the pseudo centers falls in a preset first distance range and a dihedral angle defined by the four pseudo centers falls in a preset first angle range, the secondary structure formed by an amino acid sequence corresponding to the four pseudo centers is determined to be an alpha helix; and
a 3/10 helix determination unit configured such that, under conditions in which, in the four consecutive pseudo centers, a distance between first and third pseudo centers, a distance between second and fourth pseudo centers and a distance between first and fourth pseudo centers respectively fall in preset second, third and fourth distance ranges, and a dihedral angle defined by the four pseudo centers falls in a preset second distance range, the secondary structure formed by an amino acid sequence corresponding to the four pseudo centers is determined to be a 3/10 helix.

3. The apparatus of claim 2, wherein the strand determination unit comprises:
a parallel determination unit configured such that, under conditions in which a distance between pseudo centers included in different pseudo center sequences proceeding in a same direction falls in a preset fifth distance range and a distance between consecutive pseudo centers of the pseudo centers included in the different pseudo center sequences falls in a preset sixth distance range, the secondary structure formed by amino acid sequences corresponding to the different pseudo center sequences is determined to be a parallel strand; and
an anti-parallel determination unit configured such that, under conditions in which a distance between pseudo centers included in different pseudo center sequences proceeding in opposite directions falls in a preset seventh distance range, a distance between consecutive pseudo centers of the pseudo centers included in the different pseudo center sequences falls in a preset eighth distance range, and a distance between alpha carbons respectively corresponding to the pseudo centers included in the different pseudo center sequences falls in a preset ninth distance range, the secondary structure formed by amino acid sequences corresponding to the different pseudo center sequences is determined to be an anti-parallel strand.

4. The apparatus of any one of claim 1, wherein the pseudo center fixing unit disposes the pseudo centers at central positions between two alpha carbons adjacent to each other.

5. The apparatus of claim 2, wherein, when proline is included in the amino acid sequence corresponding to the four consecutive pseudo centers, the alpha helix determination unit does not determine whether the corresponding amino acid sequence is an alpha helix.

6. The apparatus of claim 3, wherein, when all of the amino acid sequences corresponding to a plurality of consecutive pseudo center sequences are determined to be an anti-parallel strand, the anti-parallel determination unit determines whether respective pseudo centers positioned at both ends of the consecutive amino acid sequence having the anti-parallel strand are included in the anti-parallel strand depending on whether pseudo centers adjacent to an outside of the consecutive amino acid sequence relative to the pseudo centers positioned at the both ends form a hydrogen bond.

7. A method of identifying a secondary structure of a protein, comprising:
disposing pseudo centers corresponding to respective alpha carbons at positions fixed between the respective alpha carbons and alpha carbons adjacent thereto based on a series of alpha carbon coordinates included in amino acid sequences of a target protein;
determining, based on a dihedral angle and a distance between a preset number of consecutive pseudo centers among the pseudo centers fixed for the target protein, whether the secondary structure formed by a plurality of amino acids corresponding to the consecutive pseudo centers is a helix; and
determining, based on distances between pseudo centers included in different pseudo center sequences in a plurality of pseudo center sequences comprising a preset number of consecutive pseudo centers among pseudo centers other than those corresponding to the helix, whether the secondary structure formed by a plurality of amino acids corresponding to the pseudo centers of respective pseudo center sequences is a strand.

8. The method of claim 7, wherein the determining whether the secondary structure is a helix comprises:
determining, under conditions in which a distance between first and fourth pseudo centers in four consecutive pseudo centers among the pseudo centers falls in a preset first distance range and a dihedral angle defined by the four pseudo centers falls in a preset first angle range, the secondary structure formed by an amino acid sequence corresponding to the four pseudo centers to be an alpha helix; and
determining, under conditions in which, in the four consecutive pseudo centers, a distance between first and third pseudo centers, a distance between second and fourth pseudo centers and a distance between first and fourth pseudo centers respectively fall in preset second, third and fourth distance ranges, and a dihedral angle defined by the four pseudo centers falls in a preset second distance range, the secondary structure formed by an amino acid sequence corresponding to the four pseudo centers to be a 3/10 helix.

9. The method of claim 8, wherein the determining whether the secondary structure is a strand comprises:
determining, under conditions in which a distance between pseudo centers included in different pseudo center sequences proceeding in a same direction falls in a preset fifth distance range and a distance between consecutive pseudo centers of the pseudo centers included in the different pseudo center sequences falls in a preset sixth distance range, the secondary structure formed by amino acid sequences corresponding to the different pseudo center sequences to be a parallel strand; and
determining, under conditions in which a distance between pseudo centers included in different pseudo center sequences proceeding in opposite directions falls in a preset seventh distance range, a distance between consecutive pseudo centers of the pseudo centers included in the different pseudo center sequences falls in a preset eighth distance range, and a distance between alpha carbons respectively corresponding to the pseudo centers included in the different pseudo center sequences falls in a preset ninth distance range, the secondary structure formed by amino acid sequences corresponding to the different pseudo center sequences to be an anti-parallel strand.

10. The method of any one of claim 9, wherein the disposing the pseudo centers comprises disposing the pseudo centers at central positions between two alpha carbons adjacent to each other.

11. The method of claim 8, wherein, when proline is included in the amino acid sequence corresponding to the four consecutive pseudo centers, the determining the secondary structure to be an alpha helix comprises not determining for the corresponding amino acid sequence whether the corresponding amino acid sequence is an alpha helix.

12. The method of claim 9, wherein, when all of the amino acid sequences corresponding to a plurality of consecutive pseudo center sequences are determined to be an anti-parallel strand, the determining the secondary structure to be an anti-parallel strand comprises determining whether respective pseudo centers positioned at both ends of the consecutive amino acid sequence having the anti-parallel strand are included in the anti-parallel strand depending on whether pseudo centers adjacent to an outside of the consecutive amino acid sequence relative to the pseudo centers positioned at the both ends form a hydrogen bond.

13. A computer-readable storage medium, which stores a program configured to execute the method of claim 7 on a computer.

14. The computer-readable storage medium of claim 13, which stores a program configured to execute the method of claim 8 on a computer.

15. The computer-readable storage medium of claim 14, which stores a program configured to execute the method of claim 9 on a computer.
